(19) United States
(12) Patent Application Publication
(10) Pub. No.: US 2016/0080466 A1
(43) Pub. Date: Mar. 17, 2016

(54) INFORMATION PROCESSING APPARATUS AND METHOD OF REMOTE OPERATION CONTROL

(71) Applicant: FUJITSU LIMITED, Kawasaki-shi (JP)

(72) Inventor: Masatoshi KIMURA, Kawasaki (JP)

(73) Assignee: FUJITSU LIMITED, Kawasaki-shi (JP)

(21) Appl. No.: 14/949,226

(22) Filed: Nov. 23, 2015

Related U.S. Application Data
(63) Continuation of application No. PCT/JP2013/065289, filed on May 31, 2013.

(51) Int. Cl. H04L 29/08; H04M 1/725

(52) U.S. Cl. CPC H04L 67/025; H04L 67/06; H04L 67/141; H04M 1/72527

(57) ABSTRACT

An apparatus link unit of a PC and an apparatus link unit of a smartphone link with each other to automatically establish a mode of remote operation between the PC and the smartphone. When the apparatus link unit of the PC transmits a notice of completion of PC-smartphone link to the smartphone, a port number to be used in the remote operation is informed. The apparatus link unit of the PC transmits a file to the smartphone using a port number of a normal link mode while a remote operation controller is performing the remote operation.

### CROSS-REFERENCE TO RELATED APPLICATION(S)

This application is a continuation of International Application No. PCT/JP2013/065289, filed on May 31, 2013, the entire contents of which are incorporated herein by reference.

### FIELD

The embodiments discussed herein are related to an information processing apparatus, a method of remote operation control, and a computer-readable recording medium.

### BACKGROUND

There has been remote desktop connection as a function to operate a screen of a personal computer (hereinafter, referred to as a “PC”) from a remote site. As an example of software that provides a function to operate a screen of a PC from a remote site, Virtual Network Computing (VNC) is available.

There is a conventional technology that receives input of a screen transfer start request from an operator, transmits a screen reception start request to a receiving terminal, and after the transmission, transfers a screen displayed on an output apparatus to the receiving terminal (refer to Japanese Laid-open Patent Publication No. 2004-64140, for example).

In addition, a link technique is developed that automatically transmits data such as photographs and moving images of a cellular phone to a PC. The PC and the cellular phone having a link function perform mutual authentication registration and then operate the link function (refer to Japanese Laid-open Patent Publication No. 2012-217048, for example).

However, unfortunately, user operability is poor when the remote desktop connection or the VNC is used from a client apparatus that remotely operates a screen of an information processing apparatus such as a PC. Specifically, when the remote desktop connection or the VNC is used, a user needs to perform various settings on the information processing apparatus as a server. In addition, the user needs to input an IP address of the information processing apparatus, a user name, and a password from the client apparatus.

### SUMMARY

According to an aspect of an embodiment, an information processing apparatus that registers inter-apparatus link with a client apparatus in advance includes an establishing unit that establishes a remote operation mode that is a mode operated by operation with the client apparatus, with the client apparatus on the basis of a request from the client apparatus, and a controller that controls remote operation with the client apparatus after the remote operation mode has been established by the establishing unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of a PC-smartphone link system according to an embodiment;

FIG. 2 is a functional block diagram illustrating a configuration of a link unit;

FIG. 3 is a diagram illustrating an example of a data structure of profile information;

FIG. 4 is a functional block diagram illustrating a configuration of a remote operation controller;

FIG. 5 is a diagram illustrating a launcher screen;

FIG. 6 is a diagram illustrating an example of the launcher screen;

FIG. 7 is a diagram illustrating an example of status indications displayed by an apparatus link unit;

FIG. 8A is a diagram illustrating a processing sequence of a PC and a smartphone related to remote operation;

FIG. 8B is a diagram illustrating the processing sequence of the PC and the smartphone related to the remote operation;

FIG. 9 is a diagram illustrating an example of a PC link screen;

FIG. 10 is a diagram illustrating an example of a notice of PC-smartphone link mode;

FIG. 11 is a diagram illustrating an example of a setting information file;

FIG. 12 is a diagram illustrating an example of a notice of completion of PC-smartphone link;

FIG. 13 is a diagram illustrating an example of a smartphone link screen;

FIG. 14 is a diagram illustrating a software configuration;

FIG. 15 is a diagram illustrating a hardware configuration of a smartphone; and

FIG. 16 is a diagram illustrating a hardware configuration of a PC.

### DESCRIPTION OF EMBODIMENTS

Preferred embodiments of the present invention will be explained with reference to accompanying drawings. The embodiments do not limit the disclosed technology.

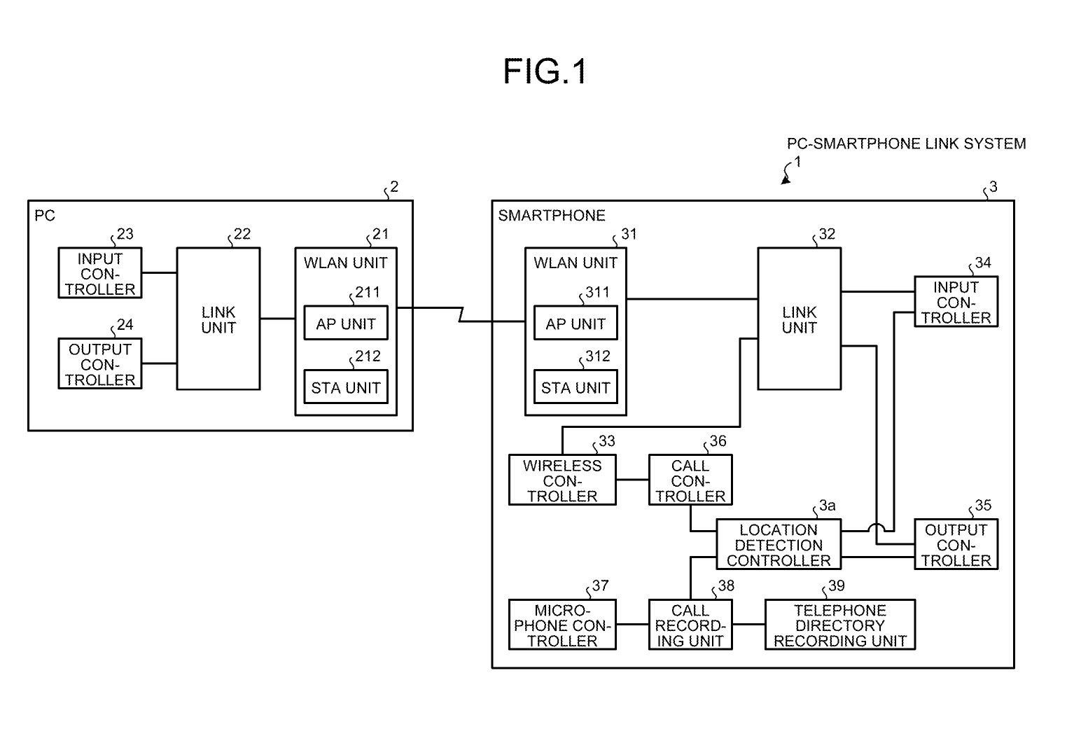

First, a PC-smartphone link system according to an embodiment will be explained. FIG. 1 is a functional block diagram illustrating a PC-smartphone link system according to the present embodiment. As illustrated in FIG. 1, this PC-smartphone link system 1 includes a PC 2 and a smartphone 3 and performs link between the PC 2 and the smartphone 3. The “link” means exchanging data such as photographs and moving images.

The PC 2 includes a WLAN unit 21, a link unit 22, an input controller 23, and an output controller 24.

The WLAN unit 21 performs communication using a wireless LAN and performs communication with a WLAN unit 31 of the smartphone 3 in the present embodiment. The WLAN unit 21 includes an AP unit 211 that causes the WLAN unit 21 to function as an access point in the wireless LAN communication and an STA unit 212 that causes the WLAN unit 21 to function as a station (client apparatus) in the wireless LAN communication.

The link unit 22 performs link with another information processing apparatus using the WLAN unit 21 and performs link with a link unit 32 of the smartphone 3 in the present embodiment. Details of the link unit 22 will be explained below.

The input controller 23 receives instructions and data input by a user using input apparatuses such as a mouse and a keyboard and passes the received instructions and data to the link unit 22. The output controller 24 displays screen information output by the PC 2 on a display apparatus and outputs voices output by the PC 2 to a speaker.

The smartphone 3 includes a WLAN unit 31, the link unit 32, a wireless controller 33, an input controller 34, an output controller 35, a call controller 36, a microphone controller 37, a call recording unit 38, a telephone directory recording unit 39, and a location detection controller 3a.

The WLAN unit 31 performs communication using the wireless LAN and performs communication with the WLAN unit 21 of the PC 2 in the present embodiment. The WLAN unit 31 includes an AP unit 311 that causes the WLAN unit 31 to function as an access point in the wireless LAN communication and an STA unit 312 that causes the WLAN unit 31 to function as a station (client apparatus) in the wireless LAN communication.

The link unit 32 performs link with another information processing apparatus using the WLAN unit 31 and performs link with the link unit 22 of the PC 2 in the present embodiment. Details of the link unit 32 will be explained below.

The wireless controller 33 performs voice communication and data communication wirelessly with another smartphone, a fixed-line phone, a computer installed by a cellular phone service provider, or the like. The input controller 34 receives instructions and data input by the user using a touch screen and passes the received instructions and data to the link unit 32. The output controller 35 displays screen information output by the smartphone 3 on a display apparatus and outputs voices output by the smartphone 3 to a speaker.

The call controller 36 controls connection, release, monitoring, or the like of the phone. The microphone controller 37 controls a microphone used for calls. The call recording unit 38 records calls. The telephone directory recording unit 39 manages a telephone directory. The location detection controller 3a performs control for position detection of the smartphone 3.

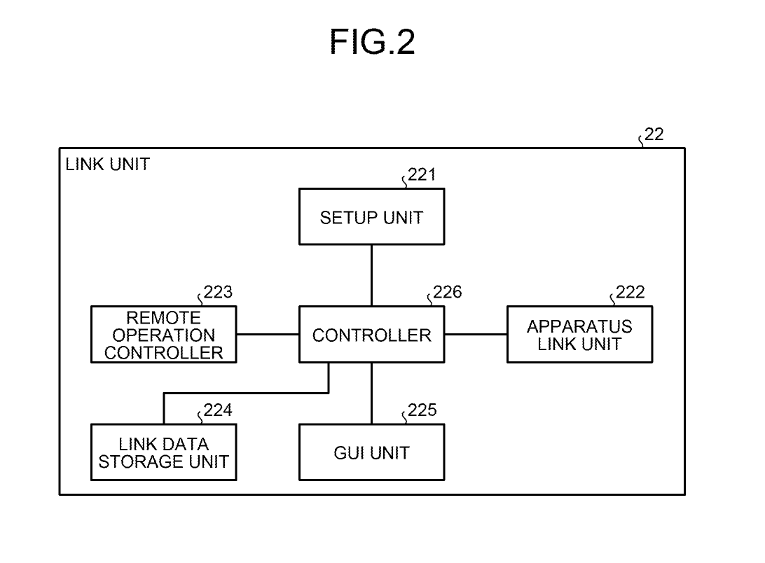

Next, a configuration of the link units 22 and 32 will be explained. The link unit 32 has a configuration basically similar to that of the link unit 22, and the link unit 22 will be explained as an example. In other words, a case in which the link unit 22 of the PC 2 links with the smartphone 3 as the other information processing apparatus will be explained as an example. As to parts of the link unit 32 different from those of the link unit 22, different points will be specified. FIG. 2 is a functional block diagram illustrating the configuration of the link unit 22.

As illustrated in FIG. 2, the link unit 22 includes a setup unit 221, an apparatus link unit 222, a remote operation controller 223, a link data storage unit 224, a GUI unit 225, and a controller 226.

The setup unit 221 performs mutual authentication with another information processing apparatus with which authentication registration has not been performed and, after mutual authentication, performs mutual registration of a service set identifier (SSID) and apparatus information. In the present embodiment, the setup unit 221 performs mutual authentication with the smartphone 3 and performs mutual registration of the SSID and the apparatus information. After the authentication registration, the setup unit 221 stores information required for link such as the SSID and the apparatus information in the link data storage unit 224.

The apparatus link unit 222 establishes link with the information processing apparatus, that is, the smartphone 3 with which mutual authentication registration has been performed. The establishment of link means establishing wireless LAN connection with the smartphone 3 and acquiring the latest profile information of the smartphone 3. The apparatus link unit 222, on the basis of information at the time of the wireless LAN connection, performs processing to capture a photograph, a moving image, and a step count and an activity amount or starts the remote operation controller 223. Meanwhile, an apparatus link unit 322 of the smartphone 3 performs processing to transmit a photograph, a moving image, and a step count and an activity amount or starts a remote operation controller 323 of the smartphone 3.

The remote operation controller 223 controls remote operation of the PC 2 operated with the smartphone 3. Specifically, the remote operation controller 223 transmits screen data and voice data of the PC 2 to the smartphone 3. The remote operation controller 323 of the smartphone 3 that has received the screen data and the voice data of the PC 2 performs screen display and voice output and receives user operation. The remote operation controller 323 of the smartphone transmits the received operation information to the remote operation controller 223 of the PC 2 and operates the PC 2 on the basis of the operation information received by the remote operation controller 223 of the PC 2. Details of the remote operation controller 223 and the remote operation controller 323 will be explained below.

The link data storage unit 224 stores therein data required for link with another information processing apparatus and stores therein an SSID when its own apparatus operates as an AP, an SSID of another information processing apparatus with which mutual authentication registration has been performed, a cryptographic key, profile information, or the like. In the present embodiment, the link data storage unit 224 stores therein the SSID when the PC 2 operates as an AP, the SSID of the smartphone 3, the cryptographic key, the profile information, or the like. When there are a plurality of information processing apparatuses with which mutual authentication registration has been performed, the link data storage unit 224 stores therein the SSID, the profile information, the cryptographic key, or the like for each information processing apparatus.

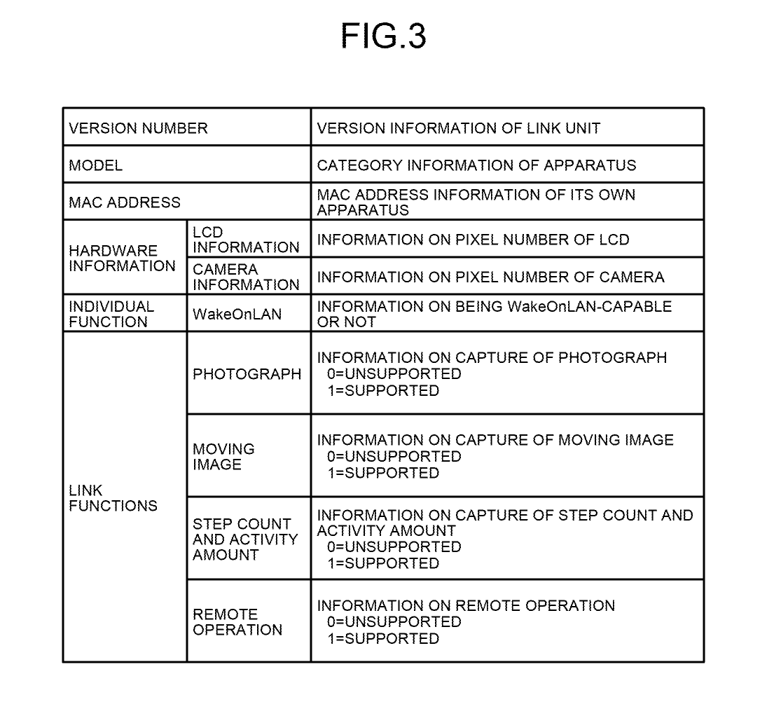

FIG. 3 is a diagram illustrating an example of a data structure of the profile information. As illustrated in FIG. 3, the profile information contains a version number, a model, a MAC address, hardware information, an individual function, and link functions.

The version number contains version information of the link unit 22 or the link unit 32 in its own apparatus. The model contains category information of its own apparatus. The model contains, for example, a distinction among a notebook personal computer, a desktop personal computer, and a cellular phone. The model may appropriately determine its contents in accordance with the category of the apparatus. The MAC address contains MAC address information of its own apparatus. The hardware information contains, for example, information on a pixel number of a liquid crystal display (LCD) and a camera. The individual function contains information on being Wake On LAN (WOL) capable or not.

The link functions contain information indicating availability of support for each of the link functions. The link functions include capture of a photograph, a moving image, and a step count and an activity amount and remote operation. When the information on the remote operation is “1,” for example, a remote operation function is supported. The profile information is stored in the link data storage unit 224 or 324 provided in its own apparatus for each apparatus and is stored therein at the time of shipping, for example.

The GUI unit 225 carries on a dialog with the user using a graphical user interface (GUI). The GUI unit 225 receives data input by the user from the input controller 23 and passes the data to the controller 226 and receives display data from the controller 226 and passes the display data to the output controller 24.

The controller 226 controls the entire link unit 22, and specifically, performs transfer of control among the functional units, passing of data between the functional units and the storage unit, or the like thereby causing the entire to function as the link unit 22.

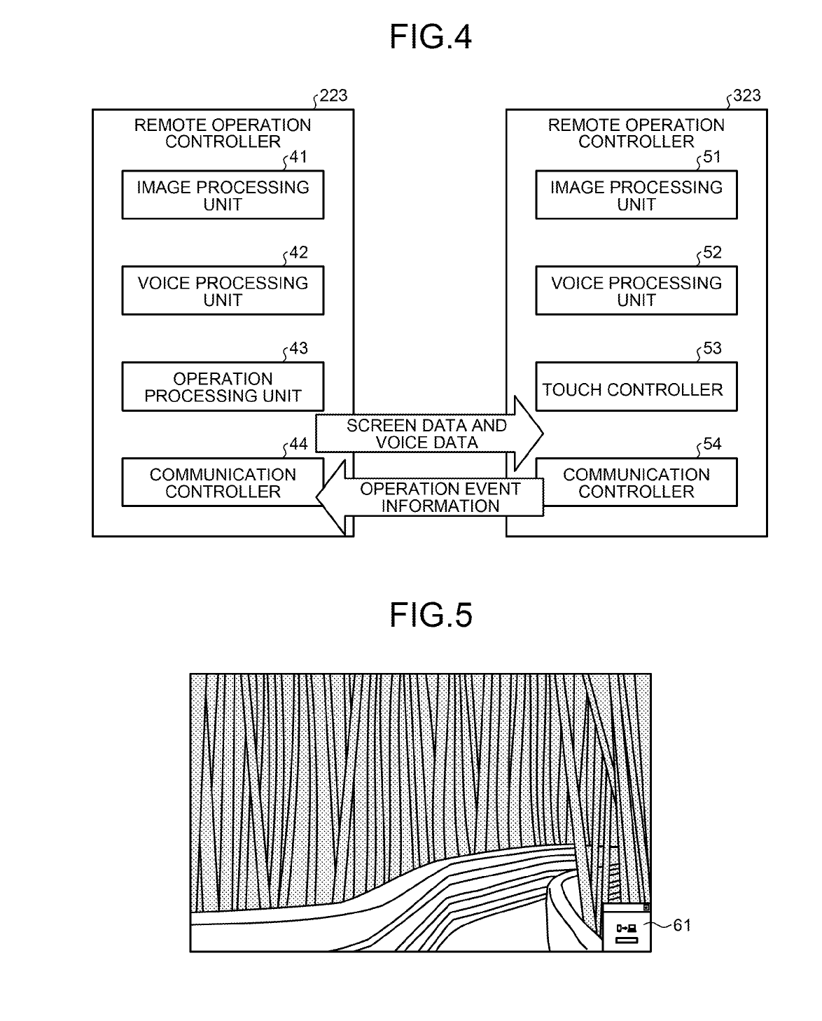

Next, the details of the remote operation controller 223 and the remote operation controller 323 will be explained. FIG. 4 is a functional block diagram illustrating a configuration of the remote operation controllers. FIG. 4 illustrates the remote operation controller 223 of the PC 2 and the remote operation controller 323 of the smartphone 3.

The remote operation controller 223 of the PC 2 includes an image processing unit 41, a voice processing unit 42, an operation processing unit 43, and a communication controller 44.

The image processing unit 41 performs capture of the screen of the PC 2, extraction of a difference with a previous screen, image compression at a location in which a difference is present, or the like to create screen data to be transmitted to the smartphone 3. The image processing unit 41 creates data of 11 screens/second, for example.

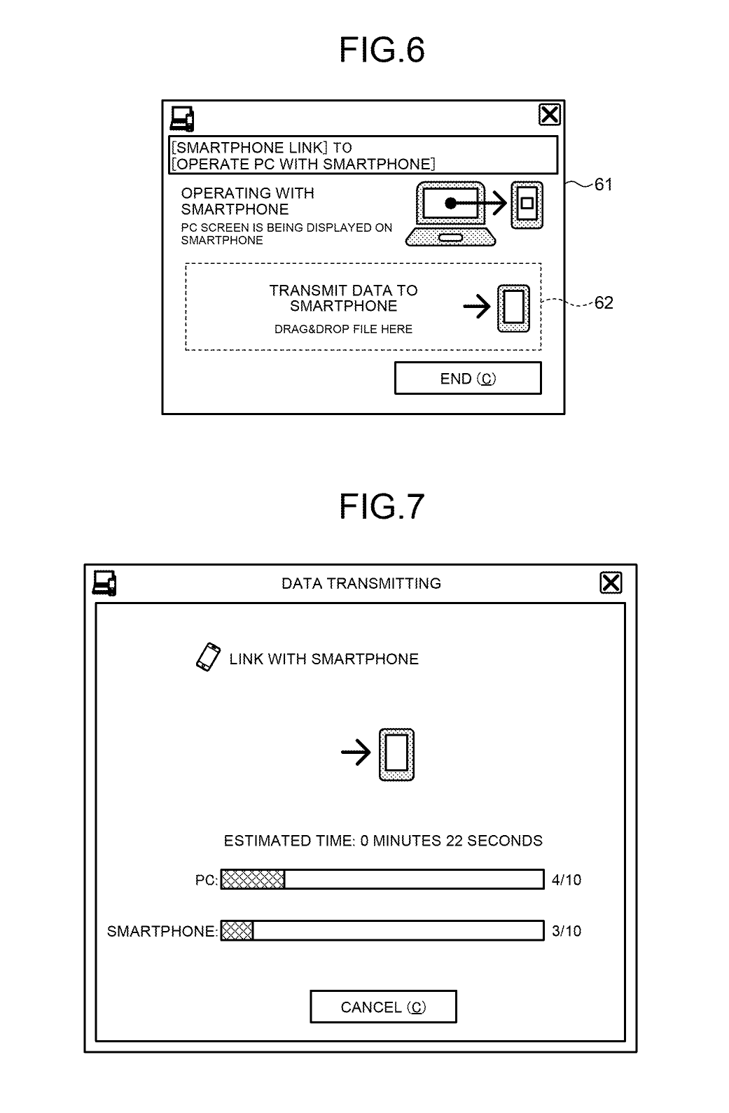

The image processing unit 41 displays a launcher screen on the screen of the PC 2. FIG. 5 is a diagram illustrating the launcher screen. As illustrated in FIG. 5, this launcher screen 61 is displayed in the lower right corner of the screen. FIG. 6 is a diagram illustrating an example of the launcher screen 61. As illustrated in FIG. 6, the launcher screen 61 displays that the PC 2 is being operated with the smartphone 3.

The launcher screen 61 includes a D&D area 62. When the user drags and drops a file or a holder in the D&D area 62 during remote operation, the apparatus link unit 222 transmits the file or the folder to the smartphone 3. Also when the user selects a file or a folder and performs an operation corresponding to a right click of a mouse during the remote operation, the apparatus link unit 222 transmits the file or the folder to the smartphone 3.

The apparatus link unit 222 displays a transmission status of the PC 2 and a reception status of the smartphone 3 on the screen of the PC 2 as status indications while transmitting the file or the folder. FIG. 7 is a diagram illustrating an example of the status indications displayed by the apparatus link unit 222. As illustrated in FIG. 7, the apparatus link unit 222 displays an estimated time until the transmission is completed, a transmission proportion, and a reception proportion on the screen of the PC 2.

The voice processing unit 42 performs capture, format conversion, and the like of voices of the PC 2 to create voice data to be transmitted to the smartphone 3. The operation processing unit 43 reflects remote operations such as key input, mouse operation, and character string input performed by the user with the smartphone 3 on the PC 2.

The communication controller 44 transmits the screen data and the voice data to the smartphone 3 and receives information on an operation event such as key input, mouse operation, and character string input from the smartphone 3. The communication controller 44 uses a network port different from a network port used for the reception of data such as photographs by the apparatus link unit 222. Consequently, while the communication controller 44 is transmitting the screen data and the voice data, the apparatus link unit 222 can transmit the file or the folder dropped in the D&D area 62 to the smartphone 3.

The remote operation controller 323 of the smartphone 3 includes an image processing unit 51, a voice processing unit 52, a touch controller 53, and a communication controller 54.

The image processing unit 51 restores a screen from the screen data transmitted from the PC 2 and displays the screen on the display apparatus of the smartphone 3. The voice processing unit 52 performs stream reproduction of the voice data transmitted from the PC 2.

The touch controller 53 generates information on the operation event such as key input, mouse operation, and character string input on the PC 2 corresponding to touch operation performed by the user with the smartphone 3. When a file or a folder is dragged and dropped on the launcher screen by the user, the touch controller 53 generates information on drag and drop as operation event information.

The communication controller 54 receives the screen data and the voice data from the communication controller 44 and transmits information on the operation event such as key input, mouse operation, character string input, and the information on drag and drop to the communication controller 44. The communication controller 54 uses the same network port as the communication controller 44.

In other words, the remote operation controller 223 of the PC 2 and the remote operation controller 323 of the smartphone 3 use a network port different from a network port used for the communication performed by the apparatus link unit 222 of the PC 2 and the apparatus link unit 322 of the smartphone 3. Consequently, the PC-smartphone link system 1 ensures security during the remote operation.

The network port used in the remote operation can be set by a user and is informed from the PC 2 to the smartphone 3 at the time of starting the remote operation.

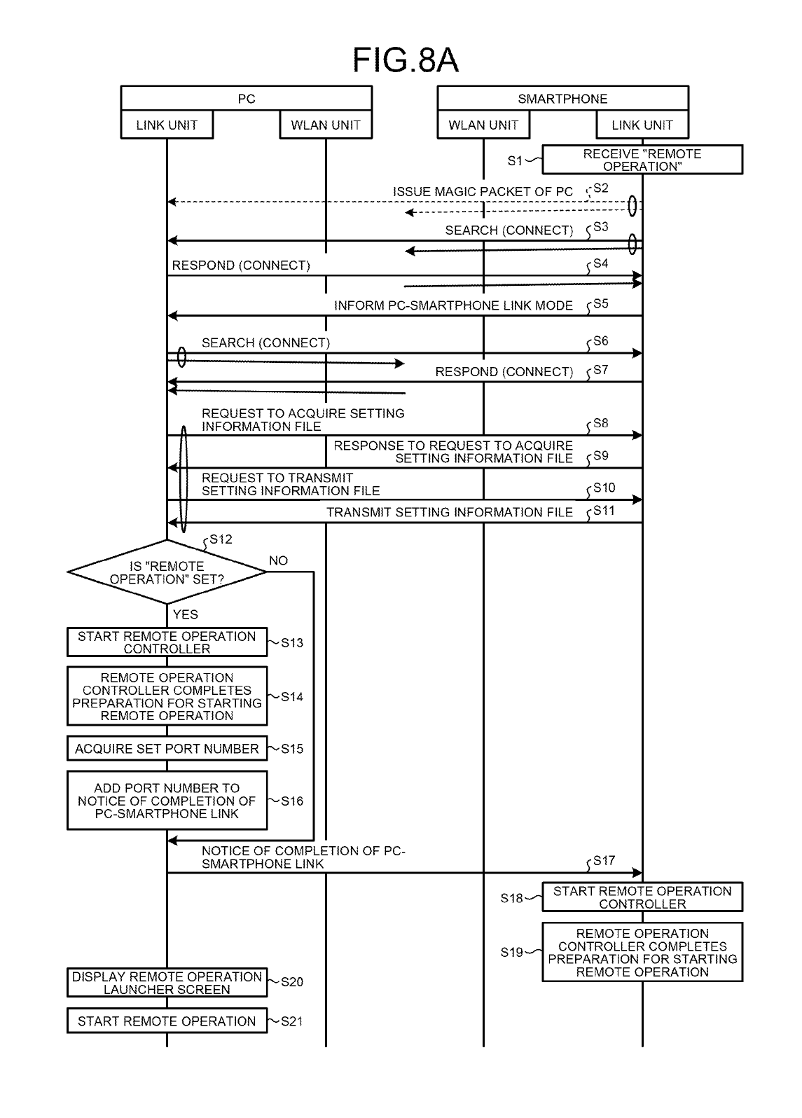

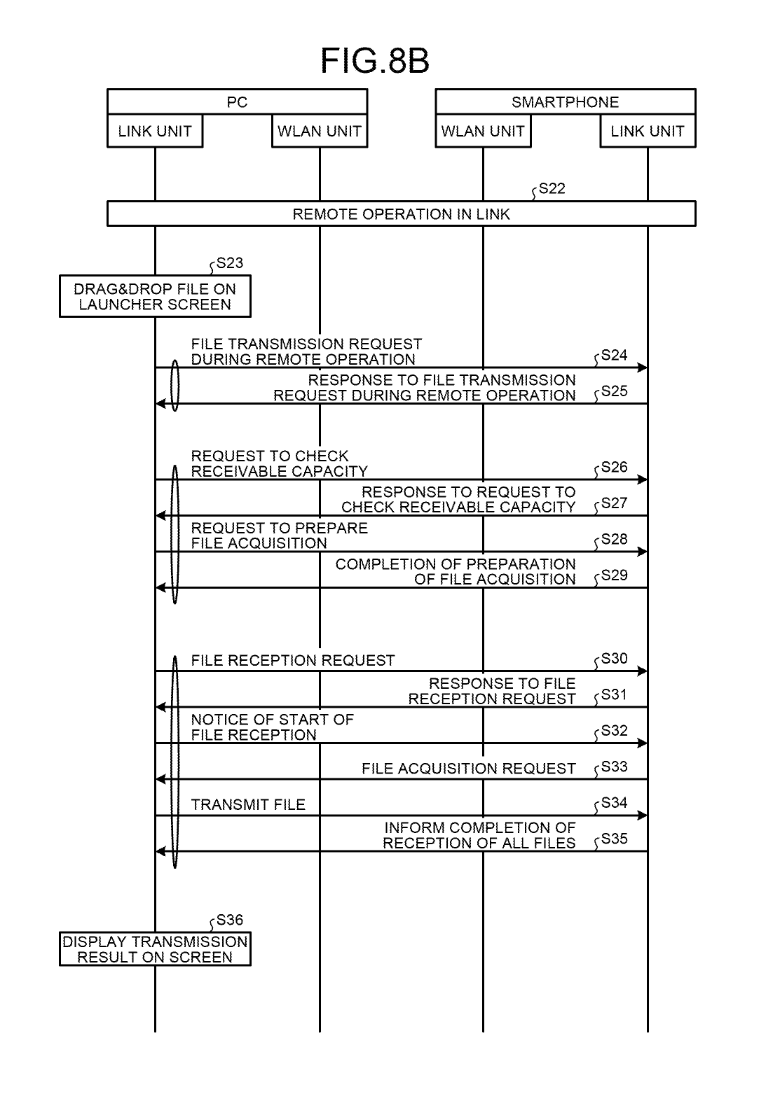

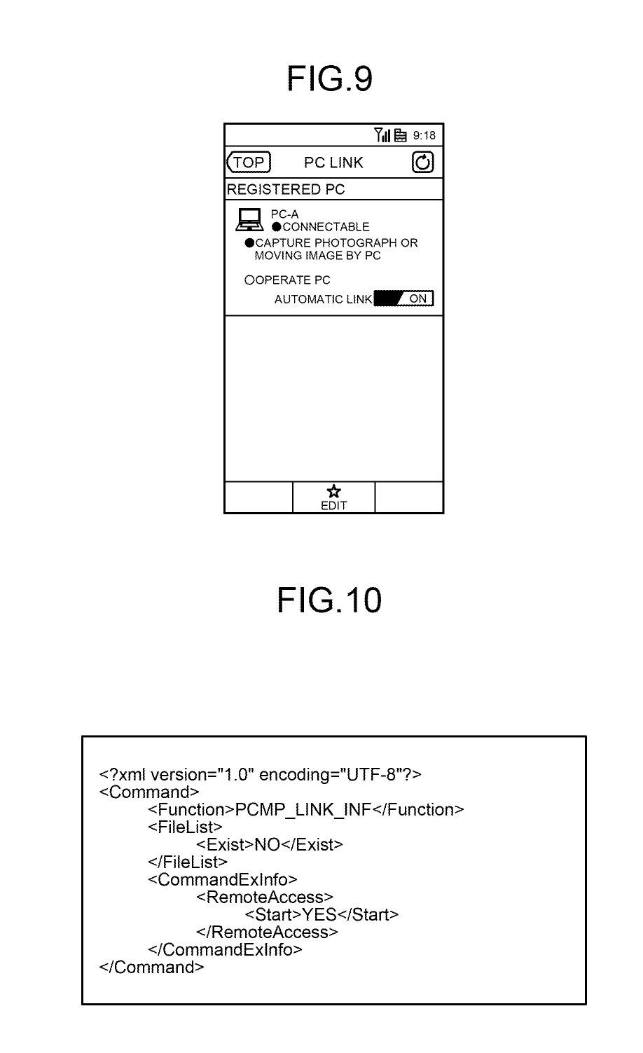

Next, processing of the PC 2 and the smartphone 3 related to the remote operation will be explained. FIG. 8A and FIG. 8B are diagrams illustrating a processing sequence of the PC 2 and the smartphone 3 related to the remote operation. In FIG. 8A and FIG. 8B, mutual authentication registration has been performed between the PC 2 and the smartphone 3 and the link unit 22 of the PC 2 and the link unit 32 of the smartphone 3 have been started by the user. It is also assumed that a PC link screen illustrated in FIG. 9 is displayed on the smartphone 3. Wireless communication between the PC 2 and the smartphone 3 is performed via the WLAN units 21 and 31.

As illustrated in FIG. 8A, the link unit 32 of the smartphone 3 receives “operate PC,” that is, “remote operation” from the user in the PC link screen illustrated in FIG. 9 (Step S1). The apparatus link unit 322 of the smartphone 3 then issues a magic packet of the PC 2 (Step S2) and starts the PC 2 when the PC 2 has not been started.

The apparatus link unit 322 performs a search so as to be connected to the PC 2 (Step S3), and the apparatus link unit 222 of the PC 2 responds so as to be connected to the smartphone 3 (Step S4). The apparatus link unit 322 of the smartphone 3 then sets “remote operation” in a notice of PC-smartphone link mode and informs the notice of PC-smartphone link mode to the PC 2 (Step S5).

FIG. 10 is a diagram illustrating an example of the notice of PC-smartphone link mode. FIG. 10 illustrates a notice of PC-smartphone link mode described in extensible markup language (XML). In FIG. 10, “remote operation” is set with <RemoteAccess><Start>YES</Start></RemoteAccess> in the tag <CommandExInfo>.

The apparatus link unit 222 of the PC 2 performs a search so as to be connected to the smartphone 3 (Step S6), and the apparatus link unit 322 of the smartphone 3 responds so as to be connected to the PC 2 (Step S7).

The apparatus link unit 222 of the PC 2 then transmits a request to acquire setting information related to the link functions as a setting information file to the smartphone 3 (Step S8). The apparatus link unit 322 of the smartphone 3 then responds to the request to acquire the setting information file to the PC 2 (Step S9).

The apparatus link unit 222 of the PC 2 then transmits a request to transmit the setting information file to the smartphone 3 (Step S10). The apparatus link unit 322 of the smartphone 3 then transmits the setting information file as a transmission response of the setting information file to the PC 2 (Step S11).

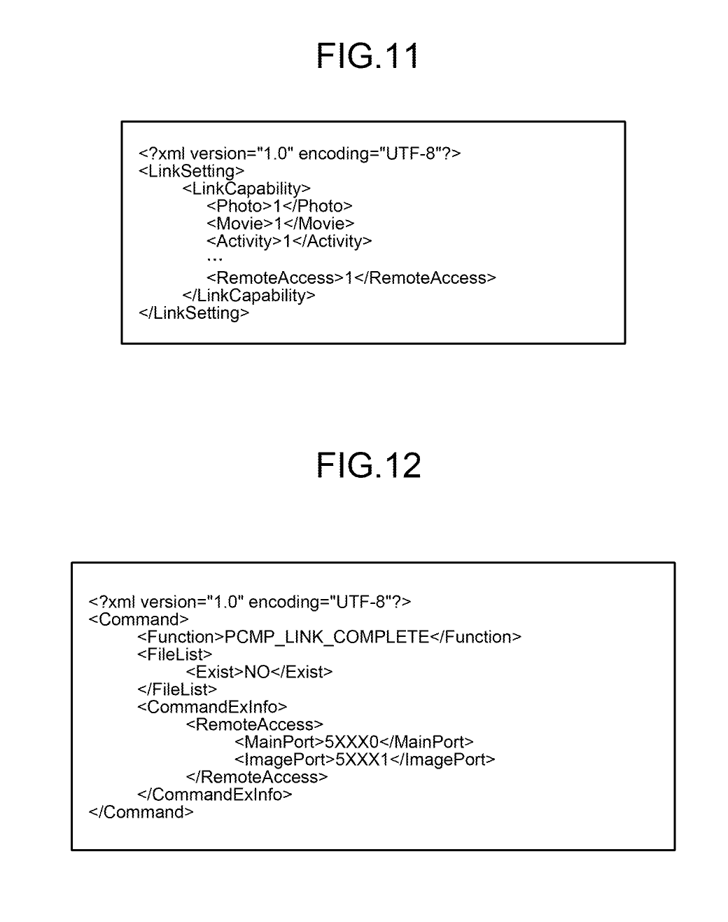

FIG. 11 is a diagram illustrating an example of the setting information file. FIG. 11 illustrates a setting information file described in XML. FIG. 11 illustrates that “remote operation” is supported by the smartphone 3 with <RemoteAccess>1</RemoteAccess> in the tag <linkCapability>.

The apparatus link unit 222 of the PC 2 determines whether “remote operation” is set in the notice of PC-smartphone link mode as the link function (Step S12), and if “remote operation” is not set, the process goes to Step S17.

By contrast, if “remote operation” is set in the notice of PC-smartphone link mode as the link function, the apparatus link unit 222 of the PC 2 starts the remote operation controller 223 (Step S13), and the remote operation controller 223 completes preparation for starting the remote operation (Step S14).

The apparatus link unit 222 of the PC 2 acquires a port number set by the user for the network port used by the remote operation controller 223 (Step S15) and adds the port number to a notice of completion of PC-smartphone link (Step S16). The apparatus link unit 222 of the PC 2 transmits the notice of completion of PC-smartphone link to the smartphone 3 (Step S17).

FIG. 12 is a diagram illustrating an example of the notice of completion of PC-smartphone link. FIG. 12 illustrates a notice of completion of PC-smartphone link described in XML. FIG. 12 illustrates that the network port used by the remote operation controller 223 is “5XXX1” with <ImagePort>5XXX1</ImagePort> in the tag <RemoteAccess>.

When the notice of completion of PC-smartphone link is received, the apparatus link unit 322 of the smartphone 3 starts the remote operation controller 323 (Step S18) and completes the preparation for starting the remote operation (Step S19). Meanwhile, the remote operation controller 223, when it is started and the preparation for the remote operation is completed, displays a launcher screen indicating the remote operation (Step S20). The foregoing processing at Step S2 to Step S20 establishes a mode of the remote operation between the PC 2 and the smartphone 3.

The apparatus link unit 222 of the PC 2 starts the remote operation (Step S21), and as illustrated in FIG. 8B, the PC 2 and the smartphone 3 become a state of being in link of the remote operation (Step S22). In other words, the screen of the PC 2 is displayed on the smartphone 3, the voice of the PC 2 is output to the smartphone 3, and the PC 2 operates on the basis of the user operation made with the smartphone 3.

If drag and drop of a file or a folder on the launcher screen by the user is detected during the remote operation (Step S23), the apparatus link unit 222 of the PC 2 transmits a file transmission request to the smartphone 3 (Step S24). The apparatus link unit 222 of the PC 2 transmits the file transmission request to the smartphone 3 also when a right click of a mouse is detected after selecting the file or the folder. The apparatus link unit 222 of the PC 2 communicates with the smartphone 3 using a network port used in a normal link mode that transmits and receives data such as photographs.

The apparatus link unit 322 of the smartphone 3 then transmits a response to the file transmission request during the remote operation to the PC 2 with attached storage folder path information of the file to be received (Step S25). The apparatus link unit 222 of the PC 2 then transmits a request to check a receivable capacity to the smartphone 3 (Step S26). The apparatus link unit 322 of the smartphone 3 then transmits a response to the request to check a receivable capacity to the PC 2 (Step S27).

The apparatus link unit 222 of the PC 2 then requests the smartphone 3 to prepare file acquisition (Step S28). The apparatus link unit 322 of the smartphone 3 then transmits completion of the preparation of file acquisition to the PC 2 (Step S29).

The apparatus link unit 222 of the PC 2 transmits a file reception request to the smartphone 3 (Step S30). The apparatus link unit 322 of the smartphone 3 then transmits a response to the file reception request to the PC 2 (Step S31).

The apparatus link unit 222 of the PC 2 then transmits a notice of start of file reception to the smartphone 3 (Step S32). The apparatus link unit 322 of the smartphone 3 then transmits a file acquisition request to the PC 2 (Step S33).

The apparatus link unit 222 of the PC 2 then transmits a file to the smartphone 3 (Step S34). While the file is being transmitted and received, the apparatus link unit 222 of the PC 2 continues to display the screen of the status indications illustrated in FIG. 7. When a plurality of files are transmitted, the apparatus link unit 222 of the PC 2 transmits the files in order.

When the reception of all files is completed, the apparatus link unit 322 of the smartphone 3 informs completion of the reception of all files to the PC 2 (Step S35). The apparatus link unit 222 of the PC 2 then displays a transmission result on the screen (Step S36). The screen of the transmission result contains folder path information of the files. The remote operation controller 223 of the PC 2 and the remote operation controller 323 of the smartphone perform remote operation control concurrently even while the files are being transferred.

As explained above, in the present embodiment, the apparatus link unit 222 of the PC 2 and the apparatus link unit 322 of the smartphone 3 cooperate with each other to automatically establish the mode of the remote operation of the PC 2 and the smartphone 3, thereby remotely operating the PC 2 easily with the smartphone 3. The apparatus link unit 222 of the PC 2 informs the port number to be used in the remote operation when the notice of completion of PC-smartphone link is transmitted to the smartphone 3, and the remote operation controller 223 communicates with the smartphone 3 using the port number informed with the notice of completion of PC-smartphone link. Consequently, network control can be made independent between the normal link mode and the mode of the remote operation. By making the network control independent between the normal link mode and the mode of the remote operation, the user can transfer files from the PC 2 to the smartphone 3 even during the remote operation.

Although in the present embodiment the remote operation controller 223 and the remote operation controller 323 establish the mode of the remote operation at the request of the smartphone 3, the mode of the remote operation can also be established at the request of the PC 2.

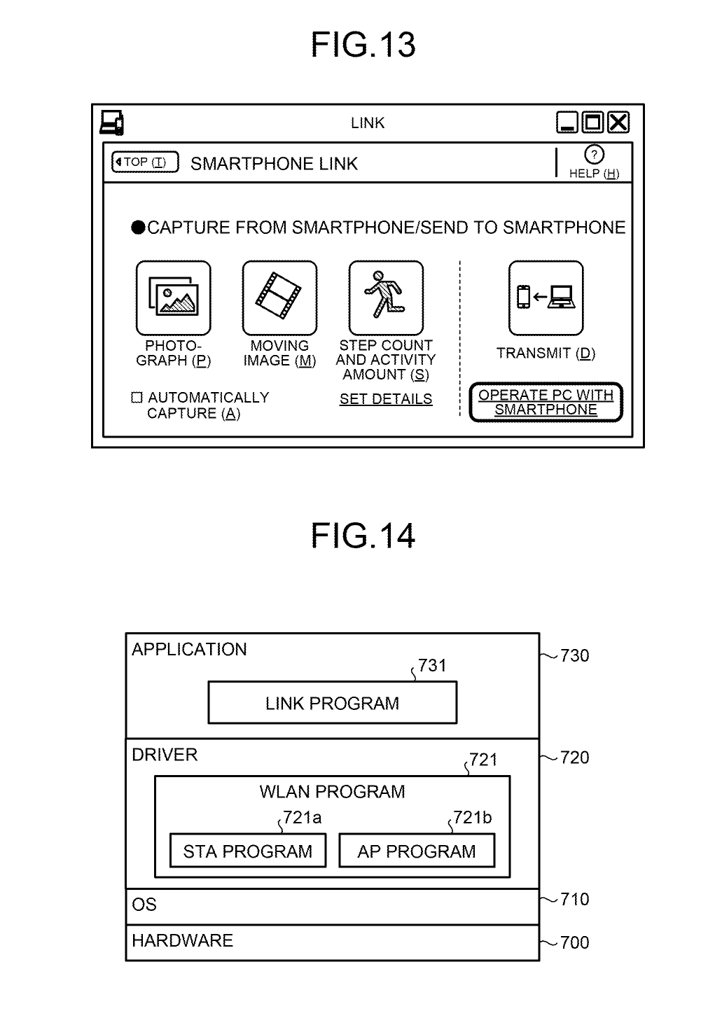

FIG. 13 is a diagram illustrating an example of a smartphone link screen displayed on the PC 2 when the apparatus link unit 222 is started. The user selects “operate PC with smartphone” on the screen illustrated in FIG. 13, thereby establishing the mode of the remote operation at the request of the PC 2.

Next, a software configuration for implementing link between the PC 2 and the smartphone 3 will be explained. FIG. 14 is a diagram illustrating the software configuration. As illustrated in FIG. 14, the software for implementing the link between the PC 2 and the smartphone 3 includes an OS 710, a driver 720, and an application 730. The OS 710, the driver 720, and the application 730 implement link processing in cooperation with hardware 700.

The driver 720 includes a WLAN program 721. The WLAN program 721 executed in the PC 2 implements the function of the WLAN unit 21 illustrated in FIG. 1. The WLAN program 721 executed in the smartphone 3 implements the function of the WLAN unit 31 illustrated in FIG. 1. The WLAN program 721 contains an STA program 721a and an AP program 721b. The STA program 721a and the AP program 721b executed in the PC 2 implement the functions of the STA unit 212 and the AP unit 211, respectively, illustrated in FIG. 1. The STA program 721a and the AP program 721b executed in the smartphone 3 implement the functions of the STA unit 312 and the AP unit 311, respectively, illustrated in FIG. 1.

The application 730 includes a link program 731. The link program 731 executed in the PC 2 implements the function of the link unit 22 illustrated in FIG. 1. The link program 731 executed in the smartphone 3 implements the function of the link unit 32 illustrated in FIG. 1. The link program 731 performs link with another information processing apparatus using the WLAN program 721. In other words, the link program 731 of the PC 2 (or the smartphone 3) performs link processing with the link program 731 of the smartphone 3 (or the PC 2).

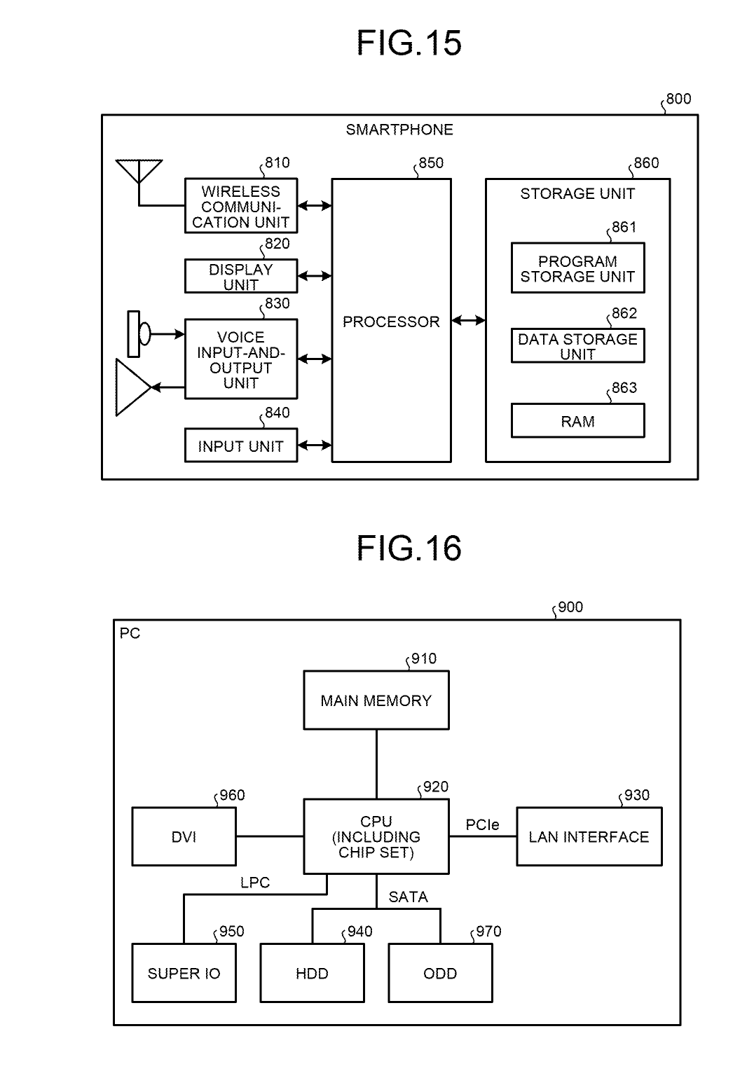

Next, the hardware 700 illustrated in FIG. 14 will be explained. FIG. 15 is a diagram illustrating a hardware configuration of a smartphone. As illustrated in FIG. 15, this smartphone 800 includes a wireless communication unit 810, a display unit 820, a voice input-and-output unit 830, an input unit 840, a processor 850, and a storage unit 860. The wireless communication unit 810, the display unit 820, the voice input and output unit 830, the input unit 840, and the storage unit 860 are separately connected to the processor 850.

The storage unit 860 includes a program storage unit 861, a data storage unit 862, and a random access memory (RAM) 863. The program storage unit 861 stores therein a computer program such as the link program 731 that implements the function of the link unit 32 illustrated in FIG. 1. The data storage unit 862 stores therein various kinds of data such as the SSID, the cryptographic key, and the profile information stored in the link data storage unit 224 illustrated in FIG. 2. The RAM 863 stores therein data or the like generated by executing the computer program.

The processor 850 is an electronic circuit such as an application specific integrated circuit (ASIC), a central processing unit (CPU), and a micro processing unit (MPU). The processor 850 reads a computer program such as the link program 731 from the storage unit 860 and loads the computer program into the RAM 863, thereby causing a computer program such as link program 731 to function as a task such as a link task. The link task appropriately loads information read from the data storage unit 862 or the like into an area assigned to itself on the RAM 863, and on the basis of the loaded data or the like, executes various kinds of data processing.

FIG. 16 is a diagram illustrating a hardware configuration of a PC. As illustrated in FIG. 16, a PC 900 includes a main memory 910, a central processing unit (CPU) 920, a local area network (LAN) interface 930, and a hard disk drive (HDD) 940. The PC 900 also includes a super input output (IO) 950, a digital visual interface (DVI) 960, and an optical disc drive (ODD) 970.

The main memory 910 is a memory that stores therein a computer program or execution halfway results of a computer program. The CPU 920 is a central processing unit that reads the computer program from the main memory 910 and executes the computer program. The CPU 920 includes a chip set having a memory controller.

The LAN interface 930 is an interface for connecting the PC 900 to another computer via a LAN. The HDD 940 is a disk apparatus that stores therein computer programs and data. The super IO 950 is an interface for connecting input apparatuses such as mouse and a keyboard. The DVI 960 is an interface for connecting a liquid crystal display apparatus. The ODD 970 is an apparatus that reads and writes DVDs.

The LAN interface 930 is connected to the CPU 920 with a PCI express, whereas the HDD 940 and the ODD 970 are connected to the CPU 920 with Serial Advanced Technology Attachment (SATA). The super IO 950 is connected to the CPU 920 with Low Pin Count (LPC).

A computer program executed in the PC 900 is stored in a DVD, is read by the ODD 970 from the DVD, and is installed in the PC 900. Alternatively, the computer program is stored in a database or the like of another computer system connected via the LAN interface 930, is read from the database, and is installed in the PC 900. The installed program is stored in the HDD 940, is read into the main memory 910, and is executed by the CPU 920.

Although the embodiment explains the PC-smartphone link system 1, the present invention is not limited thereto and can also similarly be applied to a case in which a PC is remotely operated with a tablet terminal as a client apparatus, for example.

An embodiment can improve user operability when remote operation is performed from a client apparatus.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus that registers inter-apparatus link with a client apparatus in advance, the information processing apparatus comprising:
an establishing unit that establishes a remote operation mode that is a mode operated by operation with the client apparatus, with the client apparatus on the basis of a request from the client apparatus, and
a controller that controls remote operation with the client apparatus after the remote operation mode has been established by the establishing unit.

2. The information processing apparatus according to claim 1, wherein the establishing unit establishes the remote operation mode by receiving information that designates the remote operation with the client apparatus when the inter-apparatus link is established with the client apparatus.

3. The information processing apparatus according to claim 1, wherein the controller performs communication related to the remote operation with the client apparatus using a second network identifier different from a first network identifier used for the inter-apparatus link.

4. The information processing apparatus according to claim 3, wherein
the controller receives a file identifier dragged to a certain area on a screen from the client apparatus,
the information processing apparatus further comprising a file transmitter that transmits a file identified by the file identifier received by the controller to the client apparatus using the first network identifier.

5. The information processing apparatus according to claim 4, wherein the file transmitter displays a file transmission status on the screen.

6. A method of remote operation control performed by an information processing apparatus that registers inter-apparatus link with a client apparatus in advance, the method comprising, by the information processing apparatus:
establishing a remote operation mode that is a mode operated by operation with the client apparatus, with the client apparatus on the basis of a request from the client apparatus, and
after the remote operation mode has been established, controlling remote operation with the client apparatus.

7. A non-transitory computer-readable storing medium having stored therein a program executed by an information processing apparatus that registers inter-apparatus link with a client apparatus in advance, the program causing the information processing apparatus to execute a process comprising:
establishing a remote operation mode that is a mode operated by operation with the client apparatus, with the client apparatus on the basis of a request from the client apparatus, and
after the remote operation mode has been established, controlling remote operation with the client apparatus.
